(19) United States
(12) Patent Application Publication
(10) Pub. No.: US 2024/0413370 A1
(43) Pub. Date: Dec. 12, 2024

(54) SYSTEM FOR REPLENISHING AN ON-BOARD POWER SOURCE FOR A PROPULSION SYSTEM ON A VEHICLE SUCH AS A WATERCRAFT AND PROCESS

(71) Applicant: CAMBRIA GEOSCIENCES INC., Vancouver (CA)

(72) Inventors: Paul J. MCGUIGAN, Vancouver (CA); Gilles Y. CHAMPAGNE, Offenburg (DE)

(21) Appl. No.: 18/703,858

(22) PCT Filed: Oct. 19, 2022
(86) PCT No.: PCT/CA2022/051537

§ 371 Date: Apr. 23, 2024

Related U.S. Application Data
(60) Provisional application No. 63/262,717, filed on Oct. 19, 2021.

(51) Int. Cl. H01M 8/18; B63H 21/00; B63H 21/17; B63H 21/38; H01M 8/04082; H01M 8/04186

(52) U.S. Cl. CPC H01M 8/188; B63H 21/17; B63H 21/38; H01M 8/04186; H01M 8/04201; B63H 2021/003

(57) ABSTRACT

A system and a process for replenishing an on-board power source for a propulsion system on a vehicle such as a watercraft are disclosed herein. The power source comprises a first reservoir holding an anolyte and a second reservoir holding a catholyte. The system comprises a shoreside source of DC electricity; a shoreside series of one or more interconnected stacks; and a hydraulic circuit for circulating the anolyte and catholyte. In embodiments wherein two or more shoreside interconnected stacks are used, the stacks may be hydraulically connected in series or in parallel, and electrically connected in a parallel arrangement.

### CROSS REFERENCE TO RELATED APPLICATIONS

This application claims the benefit of U.S. Provisional Patent Application 63/262,717, filed Oct. 19, 2021. The contents of the referenced application are incorporated into the present application by reference.

### BACKGROUND

### 1. Field

This disclosure relates to a system for replenishing an on-board power source for a propulsion system on a vehicle such as a watercraft and process.

### 2. Related Art

Re-chargeable batteries provide an attractive option for powering vehicles such as watercraft and trains or the like, provided they can hold enough energy to sustain typical motor loads between charges. In particular, redox flow batteries are seen as one solution since they present the feature of power/energy independent sizing making them easier to scale and to locate in a vehicle's hold.

Watercraft such as ocean bound vessels equipped with large tanks of electrolyte and a redox flow battery for powering an electric motor driving a propellor or the like have been disclosed. One drawback of these watercraft is that once depleted, the electrolyte is replaced by fresh, fully charged electrolyte, typically by pumping the depleted electrolyte out of the tanks and subsequently pumping the fresh charged electrolyte into the tanks. As the onboard stored electrolyte in some degree acts as ballast, this may lead to the watercraft becoming unstable or lead to significant differences in the height of the watercraft above the water line. This can be dangerous in the event, for example, that the electrolyte replenishment process needs to be terminated prior to completion, leaving the watercraft with reduced electrolyte volume and thus ballast. A further drawback of this replenishment process is that it requires the provision of large onshore tanks, to both hold the depleted electrolyte that is pumped out of the watercraft and the fresh, fully charged electrolyte to be pumped into the watercraft. These onshore tanks occupy significant amounts of space, in essence doubling the volume of the tanks that are present on the watercraft itself. Yet a further drawback of this replenishment process is that the redox flow battery on board the watercraft is unable to produce power during the replenishment process because the tanks must be completely emptied of depleted electrolyte prior to the transfer of fresh, fully charged electrolyte.

### SUMMARY

The present disclosure broadly relates to a system for replenishing an on-board power source for a propulsion system on a vehicle such as a watercraft and process.

In an aspect, the present disclosure relates to a system for replenishing an on-board power source for a propulsion system on a vehicle such as a watercraft, the power source comprising a first reservoir holding an anolyte and a second reservoir holding a catholyte, the system comprising: a shoreside source of DC electricity, a shoreside series of one or more interconnected stacks, each stack comprising at least one cell divided into a first half-cell compartment and a second half-cell compartment by a porous or ion selective membrane through which ions flow during a redox reaction, the at least one cell comprising a pair of electrodes, a first one of the electrodes in the first half-cell compartment and a second one of the electrodes in the second half-cell compartment; and a hydraulic circuit for circulating the anolyte from the first reservoir into the first half-cell compartment of the at least one cell and back into the reservoir tank and for circulating the catholyte from the second reservoir into the second half-cell compartment of the at least one cell and back into the second reservoir; wherein applying power from the source of DC electricity between the electrodes while operating the hydraulic circuit charges the anolyte and the catholyte.

In an embodiment of the present disclosure, the hydraulic circuit comprises at least one pump for circulating the anolyte from the first reservoir into each of the first half-cell compartment and back into the reservoir tank and for circulating the catholyte from the second reservoir into each of the second half-cell compartment and back into the second reservoir.

In an embodiment of the present disclosure, each of the stacks of the shoreside series of one or more interconnected stacks comprise at least two cells; each of the cells comprises two half-cell compartments separated by a porous or ion selective membrane; each of the half-cell compartments comprises an electrode. The cells in the one or more interconnected stacks are electrically connected in series, and the electrolyte flows in parallel through each of the cells; anolyte in one of the half-cell compartments and catholyte in the other of the half-cell compartments. In a further embodiment of the present disclosure, the system may comprise at least two stacks hydraulically connected in a series arrangement and electrically connected in a parallel arrangement.

In an embodiment of the present disclosure, the application of current from the DC power source between the electrodes while operating the hydraulic pumping circuit charges the anolyte and the catholyte, whereas connecting an electrical load between the electrodes while operating the hydraulic pumping circuit discharges the anolyte and catholyte.

In an aspect, the present disclosure relates to a process for replenishing an on-board power source for a propulsion system on a vehicle such as a watercraft, the power source comprising a first reservoir holding an anolyte and a second reservoir holding a catholyte, the process comprising: pumping the anolyte out of the first reservoir and the catholyte out of the second reservoir into a shoreside series of one or more interconnected stacks, each stack comprising at least one cell comprising a pair of half-cell compartments separated from each other by a porous or ion selective membrane through which ions flow during a redox reaction; applying a current between a first electrode in a first of the half-cell compartments and a second electrode in a second of the half-cell compartments; and returning the anolyte to the first reservoir and the catholyte to the second reservoir.

In an embodiment of the present disclosure, the pumping of the anolyte out of the first reservoir and the catholyte out of the second reservoir into a shoreside series of one or more interconnected stacks is done simultaneously.

In an embodiment of the present disclosure, the shoreside series of one or more interconnected stacks may be electrically connected to the DC power source in a parallel arrangement. In this embodiment, the electrolyte (i.e., anolyte and catholyte) flows from the watercraft into the shoreside series of one or more interconnected stacks, wherein the stacks are connected hydraulically in a series arrangement, such that the electrolyte flows from stack to stack sequentially. In this arrangement, the analyte and catholyte exit one stack and then enter the next stack of the series of interconnected stacks. When the analyte and catholyte exit the last of the series of interconnected stacks, the then charged electrolyte may be returned to their respective reservoirs on board the watercraft using the hydrolytic circuit. An advantage of this type of charging arrangement is that the electrolyte is being gradually charged when flowing from stack to stack. A further advantage of this type of charging arrangement is that the total volume of electrolyte flowing between the shoreside series of one or more interconnected stacks and the respective reservoirs on board the watercraft is limited, resulting in a more energy efficient pumping process relative to a configuration wherein the stacks are connected hydraulically in a parallel arrangement.

In an embodiment of the present disclosure, the shoreside series of one or more interconnected stacks may be electrically connected to the DC power source in a parallel arrangement. In this embodiment, the electrolyte (i.e., anolyte and catholyte) flows from the watercraft into the shoreside series of one or more interconnected stacks, wherein the stacks are connected hydraulically in a parallel arrangement, such that the electrolyte flows in parallel through the respective stacks before being returned to their respective reservoirs on board the watercraft using the hydrolytic circuit.

Also disclosed in the context of the present disclosure are embodiments 1 to 8. Embodiment 1 is a system for replenishing an on-board power source for a propulsion system on a vehicle such as a watercraft, the power source comprising a first reservoir holding an anolyte and a second reservoir holding a catholyte, the system comprising: a shoreside source of DC electricity; a shoreside series of one or more interconnected stacks, each stack comprising at least one cell divided into a first half-cell compartment and a second half-cell compartment by a porous or ion selective membrane through which ions flow during a redox reaction, the at least one cell comprising a pair of electrodes, a first one of the electrodes in the first half-cell compartment and a second one of the electrodes in the second half-cell compartment; and a hydraulic circuit for circulating the anolyte from the first reservoir into the first half-cell compartment of the at least one cell and back into the reservoir tank and for circulating the catholyte from the second reservoir into the second half-cell compartment of the at least one cell and back into the second reservoir; wherein applying power from the source of DC electricity between the electrodes while operating the hydraulic circuit charges the anolyte and the catholyte. Embodiment 2 is the system of system 1, wherein the system comprises at least two shoreside interconnected stacks. Embodiment 3 is the system of embodiment 2, wherein the at least two shoreside interconnected stacks are hydraulically connected in a series arrangement and electrically connected in a parallel arrangement. Embodiment 4 is the system of embodiment 2, wherein the at least two shoreside interconnected stacks are hydraulically connected in a parallel arrangement and electrically connected in a parallel arrangement.

Embodiment 5 is a process for replenishing an on-board power source for a propulsion system on a vehicle such as a watercraft, the power source comprising a first reservoir holding an anolyte and a second reservoir holding a catholyte, the process comprising: pumping the anolyte out of the first reservoir and the catholyte out of the second reservoir into a shoreside series of one or more interconnected stacks, each stack comprising at least one cell comprising a pair of half-cell compartments separated from each other by a porous or ion selective membrane through which ions flow during a redox reaction; applying a current between a first electrode in a first of the half-cell compartments and a second electrode in a second of the half-cell compartments; and returning the anolyte to the first reservoir and the catholyte to the second reservoir. Embodiment 6 is the process of embodiment 5, wherein the process comprises at least two shoreside interconnected stacks. Embodiment 7 is the process of embodiment 6, wherein the at least two shoreside interconnected stacks are hydraulically connected in a series arrangement and electrically connected in a parallel arrangement. Embodiment 8 is the process of embodiment 6, wherein the at least two shoreside interconnected stacks are hydraulically connected in a parallel arrangement and electrically connected in a parallel arrangement.

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this specification and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least +5% of the modified term if this deviation would not negate the meaning of the word it modifies.

The foregoing and other advantages and features of the present disclosure will become more apparent upon reading of the following non-restrictive detailed description of illustrative embodiments thereof, with reference to the accompanying drawings/figures. It should be understood, however, that the detailed description and the illustrative embodiments, while indicating specific embodiments of the disclosure, are given by way of illustration only, since various changes and modifications within the spirit and scope of the disclosure will become apparent to those skilled in the art from this description.

### BRIEF DESCRIPTION OF THE DRAWINGS/FIGURES

The following figures/drawings form part of the present specification and are included to further demonstrate certain aspects of the present specification. The present specification may be better understood by reference to one or more of these figures/drawings in combination with the detailed description. In the appended drawings/figures:

FIG. 1 illustrates a schematic diagram of a system for replenishing an on-board power source for a propulsion system on a vehicle such as a watercraft in accordance with an illustrative embodiment of the present invention; and

FIG. 2 illustrates a schematic diagram of a shoreside stack comprising a series of interconnected stacks in accordance with an illustrative embodiment of the present invention.

### DETAILED DESCRIPTION OF THE ILLUSTRATIVE EMBODIMENTS

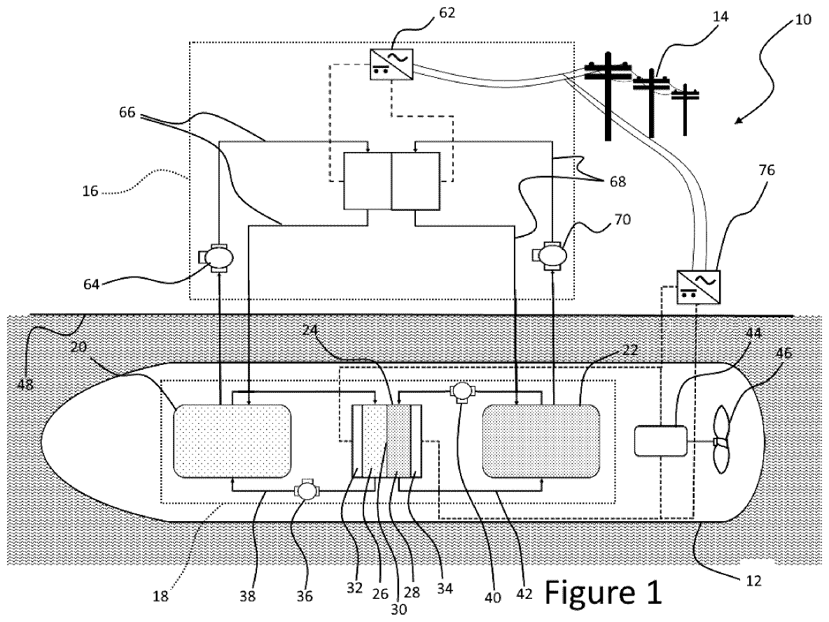

With reference to FIG. 1, a propulsion system for watercraft, generally referred to using the reference numeral 10, will now be described. The system can be separated into a movable part consisting of the vessel 12 and its associated subsystems and a fixed part, typically located on land, and comprising a power source 14, such as a windmill farm, solar panels, hydroelectric power, or the like, and a shoreside electrolyte replenishment facility 16.

Still with reference to FIG. 1, the vessel 12 illustratively comprises a redox flow battery 18. As known in the art, energy in the form of charged electrolyte for the redox flow battery 18, may be contained in at least two (2) separated reservoirs, or tanks, 20, 22. A first reservoir 20 may contain the catholyte (i.e., an electrolyte comprising redox ions which are in an oxidized state and are to be reduced during the discharge process or oxidized during the charge process), and a second reservoir 22 that may contain the anolyte (i.e., an electrolyte comprising redox ions which are in a reduced state and are to be oxidized during the discharge process or reduced during the charge process). Additionally, the redox flow battery 18 comprises at least one flow cell or stack 24, each such stack comprising a pair of half-cell compartments 26 and 28, separated by a porous or ion selective membrane 30 through which ions flow during the redox reaction. Furthermore, the redox flow battery 18 comprises a pair of electrodes 32, 34. In an embodiment of the present disclosure, the electrodes may be carbon electrodes or the like. A first of the electrodes 32 is positioned within the first half-cell 26 and a second of the electrodes 34 is positioned within the second half-cell 28.

Still with reference to FIG. 1, in operation charged electrolyte is circulated from the first reservoir 20 through the first half-cell compartment 26 under control of a first pump 36 and first hydraulic circuit 38, and from the second reservoir 22 through the second half-cell compartment 28 under control of a second pump 40 and second hydraulic circuit 42. When a load, such as a motor 44 connected to propellor 46 or the like, is connected between the electrodes 32 and 34, circulation of charged electrolyte creates a current flow via the porous or ion selective membrane 30 and between the electrodes 32 and 34. The current is supplied, for example, to the electric motor 44 on board the vessel 12 and which illustratively drives the propellor 46. Additionally, other loads such as onboard systems (not shown) can be fed with the output of the redox flow battery 18, such as lights, control equipment and the like (all not shown).

Still with reference to FIG. 1, once the energy provided by the electrolyte is depleted, the replenishing of the electrolyte may be performed while the vessel 12 is moored, for example at a dock 48, outfitted with an electrolyte replenishment facility 16.

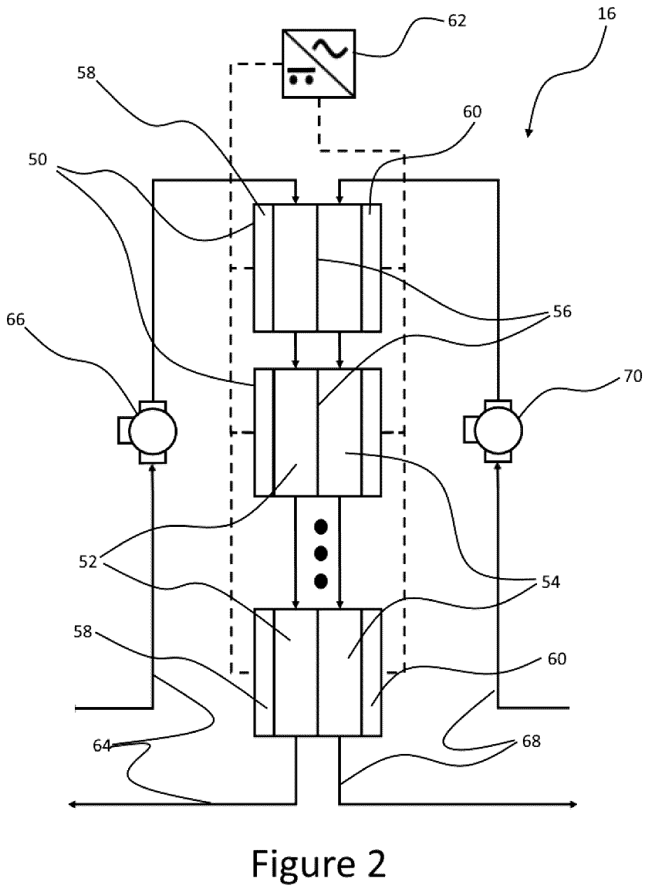

With reference to FIGS. 1 and 2, the electrolyte replenishment facility 16 may comprise one or more stacks 50. If more than one stack 50 is provided, the stacks may either be in a series arrangement or in a parallel arrangement. In embodiments where two or more stacks are hydrolytically connected in a series arrangement, the electrolyte flows from stack to stack sequentially. In this arrangement, the analyte and catholyte exit one stack and then enter the next stack of the series of interconnected stacks. Each stack may comprise one or more cells and their associated half-cell compartments. The electrolyte flows in parallel through the stack's one or more cells and associated half-cell compartments 52 and 54, separated by a porous or ion selective membrane 56. Moreover, each cell comprises a pair of electrodes 58 and 60. A first of the electrodes 58 is held within each first half-cell compartment 52 and a second of the electrodes 60 is held within each second half-cell compartment 54. Current supplied by a power source 14 may be conditioned, for example by inter alia converting a supplied AC to DC at a desired voltage range using a power converter 62 and supplied to the electrodes 58 and 60.

Still with reference to FIGS. 1 and 2, depleted electrolyte (e.g., catholyte) may be circulated out of the first reservoir 20 via a first hydraulic circuit 64 illustratively using a first circulating pump 66 into one or more of the first half-cell compartments 52. Similarly, depleted electrolyte (e.g., anolyte) may be circulated out of the second reservoir 22 via a second hydraulic circuit 68 illustratively using a second circulating pump 70 and into one or more of the second half-cell compartments 54. During circulation, current from the power converter 62 may be supplied to the electrodes 58 and 60 of each of the stack(s) 50, through which depleted electrolyte (catholyte and anolyte) is being circulated, thereby replenishing both the catholyte and anolyte. The replenished electrolyte (catholyte and anolyte) may subsequently be circulated back to their respective reservoirs 20 and 22 via their respective hydraulic circuits 64 and 68.

Still with reference to FIGS. 1 and 2, in an embodiment of the present disclosure, during the replenishment process the voltage across the electrodes 58 and 60 may be metered. The charging is completed once the metered voltage matches a desired voltage, indicating that the electrolyte in the system has been replenished to a desired state of charge. In embodiments where only a partial replenishment of the electrolyte is desired, a metered voltage corresponding to a desired partial charging may be determined.

Still with reference to FIGS. 1 and 2, in an embodiment of the present disclosure, the redox flow battery 18 on board the vessel 12 may be operated during the replenishment process, for example to provide energy to operate onboard systems and the like.

Still with reference to FIGS. 1 and 2, in an embodiment of the present disclosure, external power may additionally be supplied from a power source 14 directly to the vessel 12, for example, via a second power convertor 76 or the like. The provision of external power to the vessel 12 allows the redox flow battery 18 on board the vessel 12 to contribute to the replenishment process.

While the present disclosure has been described with reference to specific embodiments, it is to be understood that the disclosure is not limited to the disclosed embodiments. To the contrary, the disclosure is intended to cover various modifications and equivalent arrangements included within the spirit and scope of the appended claims.

1. A system for replenishing an on-board power source for a propulsion system on a vehicle such as a watercraft, the power source comprising a first reservoir holding an anolyte and a second reservoir holding a catholyte, the system comprising:
a shoreside source of DC electricity;
a shoreside series of one or more interconnected stacks, each stack comprising at least one cell divided into a first half-cell compartment and a second half-cell compartment by a porous or ion selective membrane through which ions flow during a redox reaction, the at least one cell comprising a pair of electrodes, a first one of the electrodes in the first half-cell compartment and a second one of the electrodes in the second half-cell compartment; and
a hydraulic circuit for circulating the anolyte from the first reservoir into the first half-cell compartment of the at least one cell and back into the reservoir tank and for circulating the catholyte from the second reservoir into the second half-cell compartment of the at least one cell and back into the second reservoir;
wherein applying power from the source of DC electricity between the electrodes while operating the hydraulic circuit charges the anolyte and the catholyte.

2. The system of claim 1, wherein the system comprises at least two shoreside interconnected stacks.

3. The system of claim 2, wherein the at least two shoreside interconnected stacks are hydraulically connected in a series arrangement and electrically connected in a parallel arrangement.

4. The system of claim 2, wherein the at least two shoreside interconnected stacks are hydraulically connected in a parallel arrangement and electrically connected in a parallel arrangement.

5. A process for replenishing an on-board power source for a propulsion system on a vehicle such as a watercraft, the power source comprising a first reservoir holding an anolyte and a second reservoir holding a catholyte, the process comprising:
pumping the anolyte out of the first reservoir and the catholyte out of the second reservoir into a shoreside series of one or more interconnected stacks, each stack comprising at least one cell comprising a pair of half-cell compartments separated from each other by a porous or ion selective membrane through which ions flow during a redox reaction;
applying a current between a first electrode in a first of the half-cell compartments and a second electrode in a second of the half-cell compartments; and
returning the anolyte to the first reservoir and the catholyte to the second reservoir.

6. The process of claim 5, wherein the process comprises at least two shoreside interconnected stacks.

7. The process of claim 6, wherein the at least two shoreside interconnected stacks are hydraulically connected in a series arrangement and electrically connected in a parallel arrangement.

8. The process of claim 6, wherein the at least two shoreside interconnected stacks are hydraulically connected in a parallel arrangement and electrically connected in a parallel arrangement.
